(19) United States
(12) Patent Application Publication
(10) Pub. No.: US 2008/0190803 A1
(43) Pub. Date: Aug. 14, 2008

(54) Container with lid and method for manufacturing it

(75) Inventor: Marcus Blumenschein, Marienheide (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: JOKEY PLASTIK WIPPERFURTH GMBH, Wipperfurth (DE)

(21) Appl. No.: 12/028,949

(22) Filed: Feb. 11, 2008

(30) Foreign Application Priority Data
Feb. 9, 2007 (DE) 10 2007 007 171.1

(51) Int. Cl. B65D 21/032; B65D 45/16; B23P 11/00

(52) U.S. Cl. 206/509; 220/326; 29/428

(57) ABSTRACT

On a container (1) with lid (6), particularly a paint pot, where the container (1) displays a container wall (2), a container bottom (3) and a container opening (4) and, in the edge area of the container opening (4), a continuous frame (5), projecting radially inwards relative to the container wall (2), it is envisaged that, for the purpose of simple and inexpensive manufacture, the frame (5) can be snapped onto the edge area of the container opening (4).

The invention relates to a container with lid, particularly a paint pot, where the container displays a container wall, a container bottom and a container opening and, in the edge area of the container opening, a continuous frame, projecting radially inwards relative to the container wall, into which the lid can be snapped or clamped.

The purpose of the radially inward-projecting frame located on the container opening is to prevent the material held in the container, e.g. paint, varnish and the like, from easily escaping through the container opening in the event of movement of the container. The frame moreover makes it possible to wipe off liquid material held in the container, such as paint, varnish and the like, from a tool, e.g. a brush.

The container can display any desired cross-sectional shape, especially a circular, oval, square or random rectangular cross-section.

Containers displaying a frame of this kind in the edge area of the container opening are known from the prior art. The frame can, for example, be welded to the edge area of the container. In another known embodiment, the frame is manufactured in one piece with the container by injection molding, where, for the purpose of easy removal from the mold, i.e. easy removal of the mold core from the container, it is integrally molded on the edge area of the container opening in an essentially axial position. In a further work step, the frame is then bent inwards from the essentially axial position. The geometrical design of the frame is greatly restricted by the axial integral molding of the frame on the container opening, which permits easy removal of the mold core from the container. Moreover, as with the previously mentioned welding method, further work steps are necessary to complete the container with the frame located on it. Although it is also already known practice to produce the frame, with the required position and form, in one piece with the container by injection molding, this method requires a mechanically contractable collapsible core for removal from the mold. This collapsible core makes the method complex and susceptible in terms of the technical procedure, as well as expensive in terms of economics.

The object of the present invention is therefore to develop a container of the kind mentioned in the opening paragraph in such a way that the method for manufacturing it is simpler and less expensive.

According to the invention, the object is solved in that, on a container of the kind mentioned in the opening paragraph, the frame can be snapped onto the edge area of the container opening.

The container according to the invention is characterized by its simple, less complex and cost-saving manufacture, as well as by its geometry, which can be adapted to the respective user needs and the conditions of the material held in the container. The geometry is not impaired by the necessary provision of a snap closure in the edge area of the container opening and the frame. In contrast to a frame molded in one piece together with the container, the container, the frame and the lid can be made of different materials and/or in different colors. With the snap-on frame, the edge area of the container opening can be designed in a variety of ways as regards optical and aesthetic aspects. In particular, the frame can, if necessary, be detached from the container again if the snap connection is of detachable design.

In a preferred development of the invention, the frame extends beyond the opening-side face end of the container, where its outer edge is provided with an at least essentially axial, preferably downward-pointing, projection that engages a corresponding axial groove in the edge area of the container opening. This projection radially fixes the frame on the edge area of the container opening. In this context, the groove can be designed in the manner of a depression or a stepped shoulder. The axial projection of the frame can form the radially outer border of a circumferential groove of the frame.

The radially outer side of the projection can be located in line, e.g. at least essentially or exactly in line, with the outer side of the container wall, or radially recede, preferably slightly, in relation to the outer side of the container wall. The outside diameter of the frame can thus be equal to or smaller than the outside diameter of the container in the edge area of the container opening.

The projection and the groove can extend over the entire circumference of the container. Should it be expedient on aesthetic or technical grounds, the projection and/or the groove can also extend over one or more partial areas on the circumference of the container.

Preferably, snap-in means are provided on the inner side of the edge area of the container opening, which interact with snap-in means that extend radially outwards from an area of the frame, particularly a flange part thereof. The flange part can extend essentially axially or essentially radially, or run obliquely to the principal container axis. The flange part can extend over the circumference of the container on the inner side of the edge area of the container opening. The snap-in means can extend over the circumference of the container on the inner side of the edge area of the container opening, or be distributed over the circumference thereof.

In a preferred embodiment of the invention, the inner side of the edge area of the container opening displays a groove that is engaged in snap-fitting fashion by a corresponding projection that extends outwards from an essentially axially oriented flange part of the frame. The groove located on the inner side of the edge area of the container opening has the advantage that, after injection molding of the container, the mold core is more easily removed from the container than in the case of an inward-pointing projection on the container. In certain cases, however, it can nonetheless be expedient to integrally mold a projection, instead of the groove, on the inner side of the container wall, which snaps into a corresponding groove on the outer side of the essentially axially oriented flange part of the frame.

Due to the frame extending beyond the opening-side face end of the container, with a projection oriented axially towards the container bottom, and a projection on the axially oriented flange part of the frame engaging the container wall on the inner side, a radial and axial positive connection is made between the container and the frame, which can additionally be of non-positive design. In this way, the connection between container and frame satisfies the demands on fluid-tight fastening. The essentially axially oriented flange part of the frame with the projection can extend over the entire circumference of the container, as can the groove on the inner side of the edge area of the container opening. For technical or aesthetic reasons, it may possibly also be advantageous if the flange part with the projection and the groove on the inner side of the container wall extend only over part of the container circumference.

The axial projection of the frame and the axial groove of the edge area of the container opening, which can be designed in the manner of a depression or a stepped shoulder, as well as the groove on the inner side of the container wall and the projection on the flange part of the frame, can be arranged and designed in such a way that the frame snapped onto the container sits on the container in fluid-tight fashion.

In the preferred embodiment, where the inner side of the container wall displays, in the edge area of the container opening, a groove for engagement of a projection located on the axial flange part of the frame, the container wall can, to strengthen the corresponding area, display a greater thickness in the edge area of the container opening than in the remaining areas.

On its inner circumference, the frame can display a radially inward-pointing, preferably continuous, projection, over which the lid can be snapped with a radially outwardly open groove. The continuous projection of the frame can display an axial wider area to increase its stability. The projection can be located on the axially lower area of the frame.

Lid and frame can be designed such that the lid and the frame fastened to it, which form a structural unit, can be stacked. In particular, stackability in a manner preventing radial displacement can be enabled.

In particular, provision can be made for the outer side of the edge area of the container opening to expand conically in relation to the inner side towards its opening-side face end. As the inner side of the container wall is usually inclined axially relative to the container axis, the outer side of the edge area of the container opening displays a greater inclination than the inner side. The greater material thickness of the container wall in the area of the inner-side groove can, however, also have different geometries that are suggested for certain technical or aesthetic reasons.

In the edge area of the container opening, the container according to the invention can furthermore display two diametrically opposite pegs on the outside for fastening a strap. In the event that the pegs are integrally molded on the container wall in one piece in an injection mold, the outer side of the container wall expediently displays a cylindrical section in the area of the pegs to allow easy removal of the container from the mold after injection molding.

Each of the two ends of the strap can display an eye that can be fitted onto the peg over radial projections on the circumference of the respective peg. The strap eyes are then mounted in rotating fashion between the container wall, which preferably displays a cylindrical section in the area of the two pegs, and the radial projections of the peg. The strap with the two eyes can also be molded on the container in one piece, e.g. by injection molding. In this case, it is expedient if the eyes are radially opposite the respective pegs and connected to the pegs by ties after molding, after which a radially inward force can be applied to the eyes to fit them onto the pegs over the radial projections of the pegs, breaking the ties.

In a further embodiment of the container according to the invention, the radially outer area of the outer side of the container bottom is provided with an axially projecting foot that, when stacking multiple containers with attached frames on each other, can engage a corresponding axial depression on the edge of the frame. As a result of engagement of the foot in the axial depression of the frame extending beyond the opening-side face end of the container, a further container stacked on top of the container is radially fixed in place and cannot slip.

The depression on the edge of the frame for engagement of the foot of a container stacked on top can extend up to the outer side of the frame and thus form a stepped depression towards the radial outer side.

Radially inwards, the depression transitions, after the rectangular step, into an area of the frame with a trapezoidal cross-section, which is followed by a conical area of the frame that preferably extends radially inwards towards the container bottom. The end of the conical area can display a radially inward-pointing projection, over which the lid can be snapped onto the projection, via a groove opening radially outwards, or clamped on.

In a further embodiment of the invention, where the container wall is of essentially conical design and the lower area of the inner side of the container displays multiple, essentially axially oriented stacking ribs distributed over the circumference, the outer side of the container bottom can be provided, at points correspondingly distributed over the circumference, with recesses that, when stacking multiple containers in each other, can be engaged by the stacking ribs of a container respectively located beneath. As a result of these recesses, the containers stacked in each other, which are not yet fitted with frames, are supported in a manner preventing rotation about the container axis.

In the event of an essentially annular foot being provided on the container bottom, the recesses can be designed as interruptions at correspondingly distributed points.

The container, the frame, and the lid can satisfy different requirements regarding material and color and, as they are manufactured separately, can be made of correspondingly different materials or be of correspondingly different colors.

The invention furthermore permits a method for manufacturing a container according to the embodiments described above and filling the container with material, where the container, the frame and the lid are each manufactured separately, the lid is fastened to the frame to form a unit, and the unit comprising lid and frame is fastened on the container after filling.

According to the previously known methods, the container is connected to the frame before filling with the respective material, the frame being secured in its final position on the edge area of the container opening by ultrasonic welding, integral molding with subsequent bending, or in complex fashion by integral molding. The container with frame is subsequently filled with paint, varnish or the like, after which the lid is snapped or clamped into the frame. It has, however, become apparent that it is technically more favorable to fill the container before fastening the frame. The present invention therefore offers the possibility of manufacturing the container more simply, including filling it with material, e.g. paint, varnish and the like, and thus of saving time and expense. After filling of the container, the unit comprising frame and lid can be fastened on the container opening by a simple procedure.

Should it be necessary, the frame can be detachable from the container again, either after removing the lid or together with the lid.

The invention is described in more detail below, based on the drawings. The Figures show the following:

FIG. 1 A longitudinal section through a practical example, comprising a container, a frame and a lid,

FIG. 2 An enlarged view of edge area A in FIG. 1, at the location of a peg,

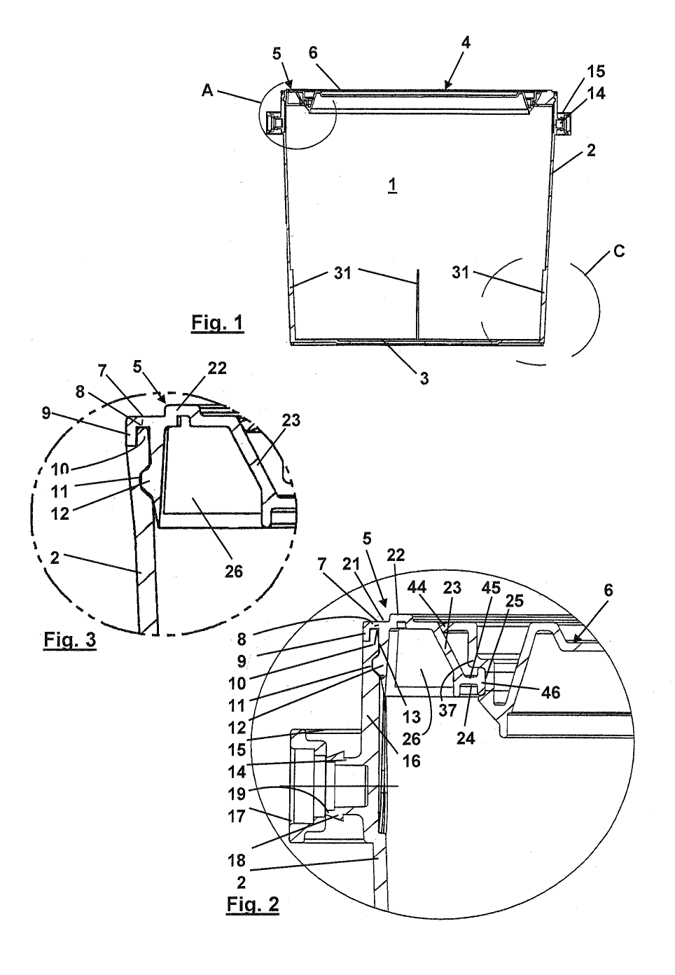

FIG. 3 A view of the edge area outside the pegs,

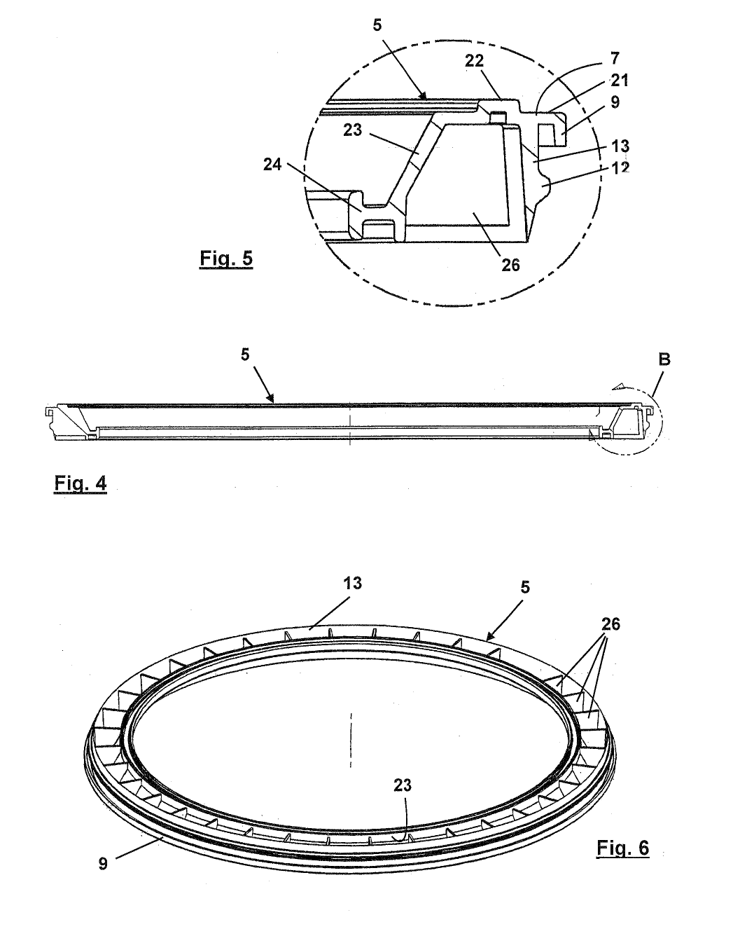

FIG. 4 A longitudinal section through the frame shown in FIGS. 1 and 2,

FIG. 5 An enlarged view of edge area B in FIG. 4,

FIG. 6 A perspective view of the underside of the frame shown in FIG. 4,

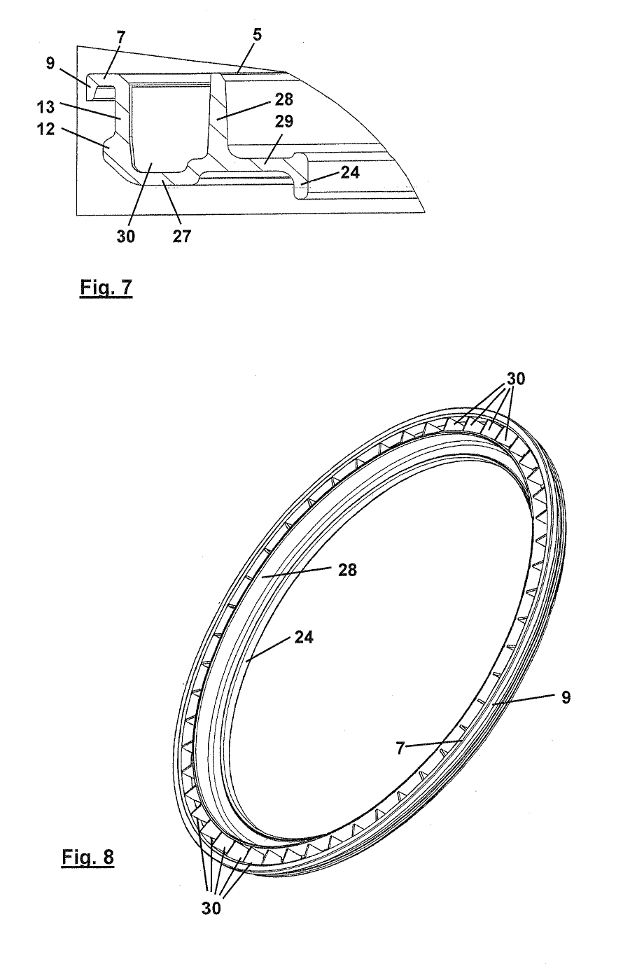

FIG. 7 A section through the edge area of another practical example of the frame,

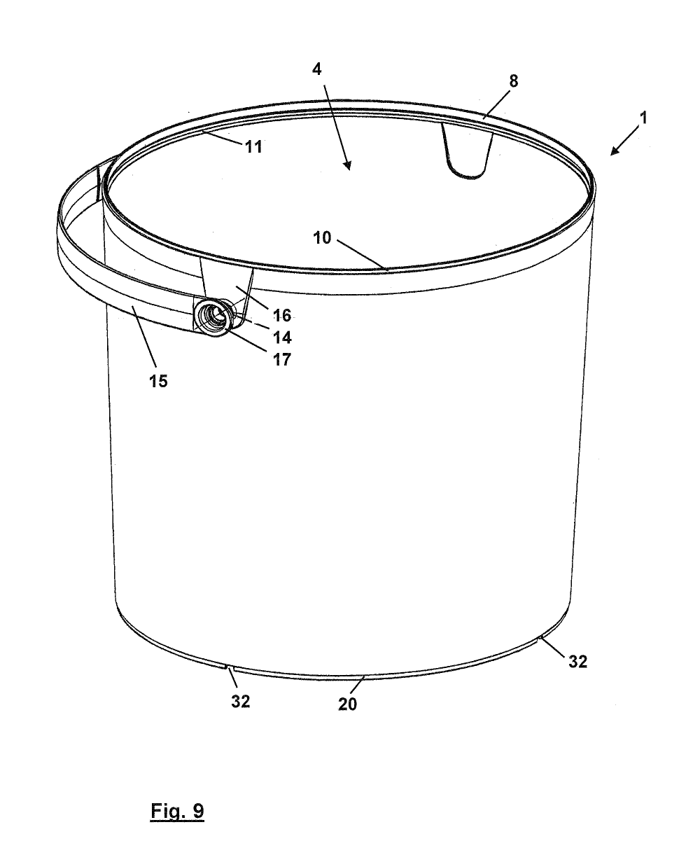

FIG. 8 A perspective view of the upper side of the frame shown in FIG. 7,

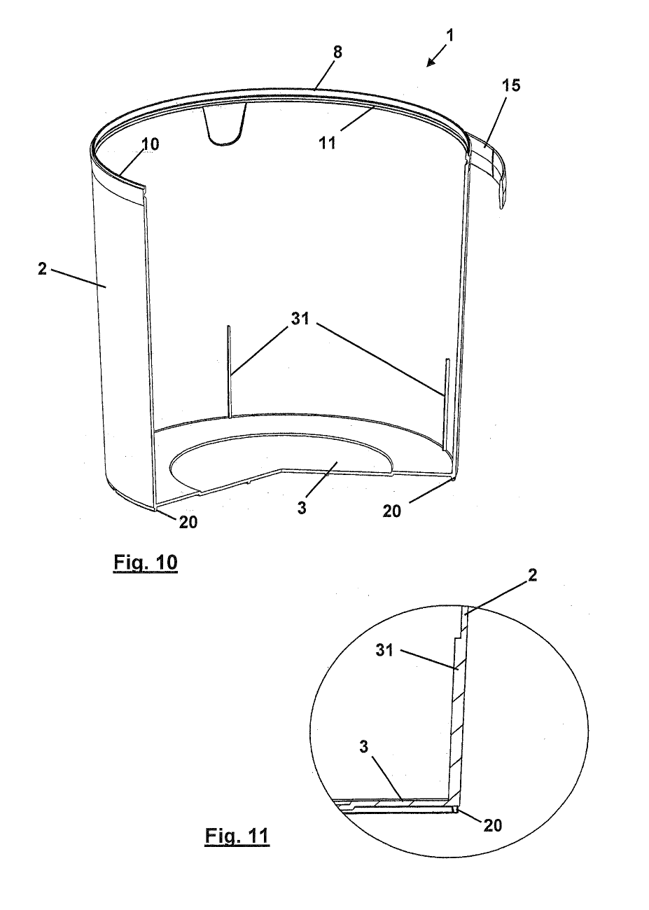

FIG. 9 A perspective view of the container shown in FIG. 1,

FIG. 10 A perspective and cutaway view of the container shown in FIG. 9,

FIG. 11 An enlarged view of area C in FIG. 1,

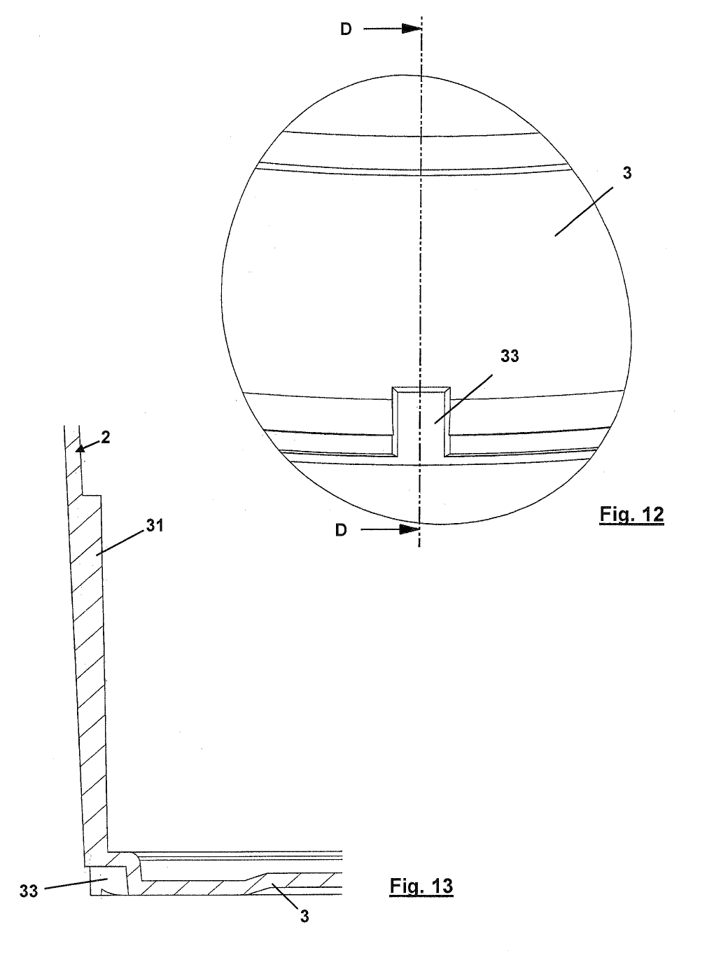

FIG. 12 A view of the container bottom from below,

FIG. 13 A section along line D-D in FIG. 12,

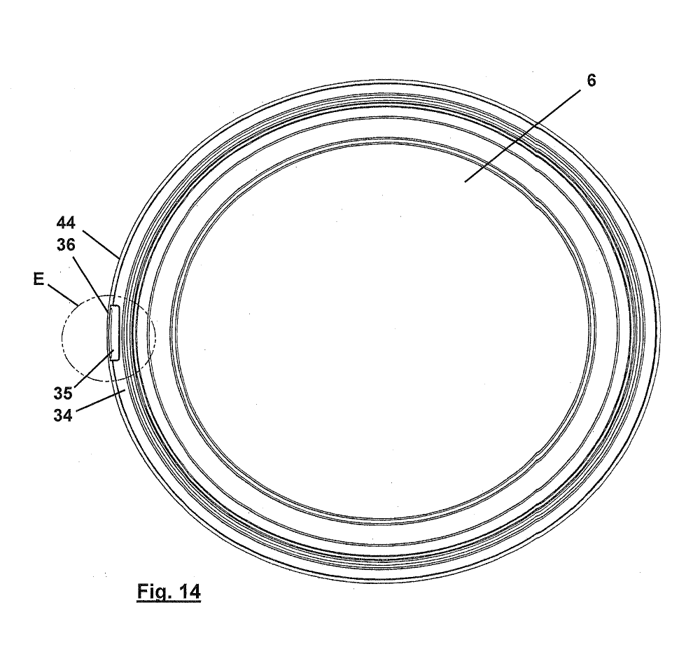

FIG. 14 A top view of an embodiment of the lid of the container shown in FIGS. 1 and 2,

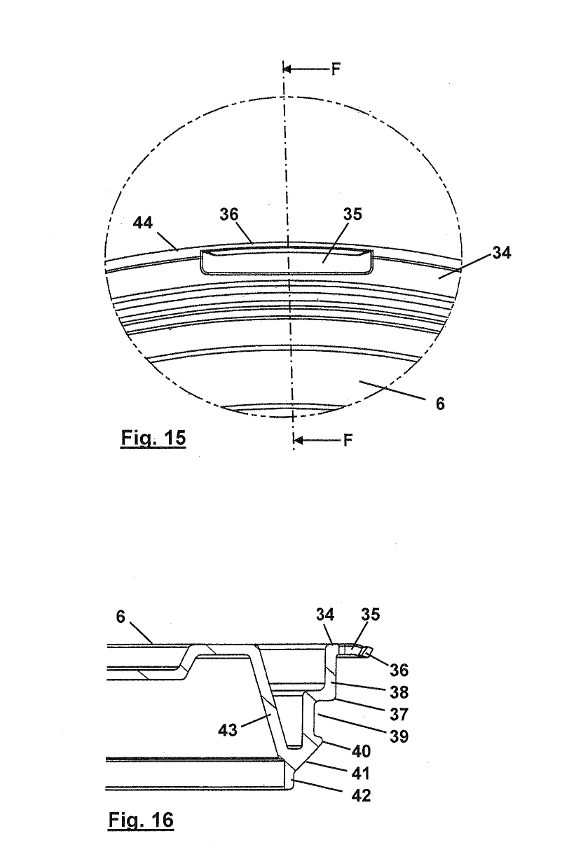

FIG. 15 An enlarged view of edge area E in FIG. 14, and

FIG. 16 A sectional view along line F-F in FIG. 15.

FIGS. 1 and 2 show a container 1, designed as a paint pot, with a container wall 2, a container bottom 3 and a container opening 4. Provided in the edge area of container opening 4 is a continuous frame 5, which projects radially inwards relative to container wall 2 and into which a lid 6 can be snapped.

In the present practical example, container 1 has a circular cross-section and is, like frame 5 and lid 6, made of plastic.

As can furthermore be seen from FIGS. 2 and 3, radially outer edge area 7 of frame 5 extends beyond opening-side face end 8 of the container, having an axial projection 9 that engages a corresponding axial groove 10 in the edge area of container opening 4, which is designed in the manner of a stepped shoulder in this instance.

The radially outer side of projection 9 is arranged in line with the outer side of container wall 2. Projection 9 and groove 10 extend over the entire circumference of the container. They fix frame 5 in radially immovable place in the edge area of container opening 4.

The inner side of the edge area of container opening 4 displays a groove 11, which is engaged in snap-fitting fashion by a corresponding projection 12, which extends outwards from an essentially axially oriented flange part 13 of frame 5. Due to edge area 7 with projection 9 extending beyond opening-side face end 8, and projection 12 on axial flange part 13 of frame 5 engaging groove 11 on the inner side of container wall 2, a radial and axial positive connection is made between container 1 and frame 5. Furthermore, the edge areas of container opening 4 with the two grooves 10 and 11, and of frame 5 with the two projections 9 and 12, are designed in such a way that the connection is also non-positive.

As shown in FIGS. 2 and 3, in particular, container wall 2 displays, in the edge area of container opening 4 where circumferential groove 11 is located, a greater thickness than in the remaining areas of container wall 2 in order to strengthen this area. As can be seen from FIG. 3, the outer side of the edge area of container opening 4 widens conically in relation to the inner side towards its opening-side face end 8. Since the inner side of container wall 2 is axially inclined relative to the container axis, the outer side of the edge area of container opening 4 displays a greater inclination compared to the inner side.

As can be seen from FIGS. 1 and 2, the edge area of container opening 4 furthermore displays two diametrically opposite pegs 14 on the outside for fastening a strap 15. Pegs 14 are integrally molded on container wall 2 in one piece. For easy removal from the mold, container wall 2 displays a cylindrical section 16 in the area of pegs 14.

Each of the two ends of strap 15 displays a strap eye 17 that can be fitted onto peg 14 over radial projections 18 on the circumference of the respective peg 14. Strap eyes 17 are then mounted in rotating fashion between cylindrical sections 16 of container wall 2 and radial projections 18 of pegs 14.

Strap 15 with the two strap eyes 17 is likewise molded with container 1 in one piece. After molding, strap eyes 17 are, as shown in FIG. 2, radially opposite the respective pegs 14, and connected to pegs 14 by ties 19. By subjecting strap eyes 17 to a radially inward force, strap eyes 17 can be fitted onto pegs 14 over radial projections 18 of pegs 14, breaking ties 19.

As can particularly be seen from FIGS. 1 and 11, as well as FIGS. 9 and 10, an axially projecting foot 20 is provided in the radially outer area of the outer side of container bottom 3. When stacking multiple containers 1 with attached frames 5 on each other, foot 20 can engage a corresponding axial depression 21 in outer edge area 7 of frame 5. As a result of engagement of foot 20 in axial depression 21 of frame 5 extending beyond opening-side face end 8 of container 1, a further container stacked on top of container 1 is radially fixed in place and cannot slip. As can particularly be seen from FIGS. 2, 3 and 5, depression 21 extends up to the outer side of frame 5, thus forming a stepped depression.

Radially inwards, depression 21 transitions, after the rectangular step, into a radially projecting area 22 of frame 5 with a trapezoidal cross-section. Radially inwards, this area is followed by a conical area 23 of frame 5 that extends towards container bottom 3. The end of conical area 23 displays a radially inward-pointing projection 24, over which lid 6 can be snapped on via a groove 25 opening radially outwards.

Located between axially oriented flange part 13 and conical area 23 of frame 5 are ribs 26, spaced apart from each other and distributed over the circumference, for increasing the stability of frame 5, as can also be seen from FIG. 6.

FIG. 7 shows a further practical example of a frame 5. Edge area 7 of frame 5, reaching beyond opening-side face end 8 of the edge of container opening 5 is likewise located on an axial flange part 13, which displays a radially outward-protruding projection 12 for engaging a corresponding groove 11 on the inner side of container wall 2. Radially inwards, the lower end of annular flange part 13 transitions into an essentially annular part 27. Radially inwards, annular part 27 is followed by an annular flange 28 running axially to edge area 7, which is in turn followed, radially inwards, by an annular area 29, on which projection 24 is located for snap-fitting fastening of lid 6. Provided between annular flange 28 and radially outer axial flange 13 are radially oriented ribs 30, distributed over the circumference, for increasing the stability of frame 5. While the annular area reinforced by ribs 26 between conical flange 23 and radially outer axial flange 13 is open towards container bottom 3 according to the practical example in FIGS. 1 to 6, the annular area reinforced by ribs 30 between axial annular flange 28 and radially outer axial flange 13 is open towards the upper side of frame 5, such that material held in container 1, e.g. paint or varnish, cannot penetrate this area and settle there.

FIG. 8 shows a top view of the practical example of frame 5 according to FIG. 7.

As can be seen from FIGS. 1 and 10, in particular, container wall 2 is of essentially conical design. On its inner side, in the area adjacent to container bottom 3, container 1 displays multiple, essentially axially oriented stacking ribs 31, distributed over the circumference. The purpose of stacking ribs 31 is that, when stacking multiple containers 1 before fitting frame 5 and lid 6, a container respectively located in container 1 can be supported, such that jamming of conical container walls 2 of the two containers is avoided. Owing to being supported by stacking ribs 31, a slight clearance remains between container walls 2, meaning that the two containers stacked in each other can easily be separated again. The containers supported by stacking ribs 31 are arranged inside each other in such a way that the edge area of the container opening of the respectively upper container, with cylindrical section 16 in the area of pegs 14 and strap 15, is located outside container opening 4 of the respectively lower container.

To fix in place a container stacked in container 1 in non-rotating fashion relative to container 1, foot 20 on container bottom 3 of container 1 displays interruptions 32, distributed over the circumference in accordance with stacking ribs 31, which can be engaged by the upper edge of stacking ribs 31 of a container 1 stacked beneath.

FIGS. 12 and 13 show a further practical example for fixing containers 1 stacked in each other in place in non-rotating fashion. In this instance, the radially outer side of container bottom 3 displays recesses 33, distributed over the circumference, which can each be engaged by the upper edge of stacking ribs 31, correspondingly distributed over the circumference, of a container stacked beneath.

A lid 6, as illustrated in FIG. 14, is expediently used with frame 5. Radially outer edge area 34 of lid 6 displays an opening area 35, through which a tool serving as a lever can extend through the lid edge for the purpose of opening lid 6. Opening area 35 is designed in the form of a slot extending in the circumferential direction of edge area 34. The radially outward-pointing edge of the slot is designed as a narrow web 36, which can be torn when levering open lid 6.

For opening lid 6, an edge 37 is located on lid 6 below opening area 35, under which the free end of the lever tool can be applied to lid 6, and by means of which lid 6 can be lifted off the opening edge of the container, at least around opening area 35, by swinging the tool over the edge of web 36 facing towards opening area 35 and against edge 37 of lid 6.

Web 36, which can be torn when levering open lid 6, serves as a tamper-proof seal, i.e. to indicate whether or not the lid has already been lifted off the opening edge of the container, if only partially, by means of a suitable tool.

In another practical example, not shown in the drawings, the opening area is designed in such a way that, prior to insertion of a lever tool, it is sealed by a cover connected to the edge of the opening area by ties. The cover and the ties are designed in such a way that a lever tool open to consideration cannot be inserted into the opening area up to the tool application edge of the lid on the inside without tearing the ties. In this case, the cover serves as the tamper-proof seal, indicating, by tearing-off of the ties, whether an attempt has been made to detach lid 6 from container 1.

As shown in FIG. 16, in particular, radially outer edge area 34 of lid 6 is designed in the form of an essentially radially extending flange. Radially inwards, this flange is followed by an area having an essentially V-shaped cross-section, with an essentially axially extending circumferential part 38 with an indentation 39 on the outer side, the radially outer edge 37 of which forms the tool application edge of lid 6. Indentation 39 is designed as a radially inward-facing right-angle bend.

Furthermore, the end of indentation 39 facing away from edge area 34 of lid 6 displays a radially outward-pointing annular projection 40, the outer side of which transitions into an inwardly sloping surface 41. Sloping surface 41 is followed by an axial annular flange 42. A conical area 43 extends radially inwards and away from annular flange 42, roughly up to the level of outer edge area 34 of lid 6.

As can furthermore be seen from FIGS. 15 and 16, web 36, which delimits opening area 35 of lid 6, and outer edge 44 of lid 6 following on from it, run outwards and downwards, i.e. towards annular flange 42, on an incline. The significance of this inclined profile is as follows: if lid 6 is fastened on frame 5 of container 1, outer edge 44 and web 36 of lid 6 are, as can be seen in FIG. 2, in contact with conical area 23 of frame 5, or only a small distance away from it, meaning that a tool open to consideration for levering open lid 6 cannot reach between edge 44 or web 36 and conical area 23. The inclined profile of edge 44 or web 36 furthermore prevents application of the tool on the outer, upper edge of edge 44 or web 36 to lever open edge area 34 of the lid and penetration between outer edge 44 of lid 6 and conical area 23 of frame 5.

FIGS. 2 and 16 furthermore show that there is a gap between conical area 23 of frame 5 and edge 37 for application of the lever tool, such that the free end of the tool can be inserted between conical area 23 and edge 37, and act beneath edge 37. To this end, projection 24, following on from conical area 23 of frame 5 in the radially inward direction, is of T-shaped design. It has a radially oriented annular web 45, extending into indentation 39 on the outer side of axially oriented part 38 of lid 6. At its end, web 45 displays an annular, axial wider area 46, which snaps in between edge 37 and annular projection 40 of lid 6. Due to the T-shape of projection 24, a space remains between edge 37 of the lid and conical part 23 of frame 5, through which the tool can extend to underneath edge 37.

### LIST OF REFERENCE NUMBERS

### 1 Container

2 Container wall
3 Container bottom
4 Container opening

### 5 Frame

### 6 Lid

7 Edge area
8 Opening-side face end
9 Axial projection
10 Axial groove

### 11 Groove

### 12 Projection

13 Flange part

### 14 Peg

### 15 Strap

16 Cylindrical section

### 17 Strap eye

### 18 Projection

### 19 Tie

### 20 Foot

### 21 Depression

22 Trapezoidal area
23 Conical area

### 24 Projection

### 25 Groove

### 26 Rib

27 Annular part
28 Annular flange
29 Annular area

### 30 Rib

### 31 Stacking rib

### 32 Interruption

### 33 Recess

34 Edge area
35 Opening area

### 36 Web

### 37 Edge

38 Circumferential part

### 39 Indentation

### 40 Projection

41 Inwardly sloping surface
42 Annular flange
43 Conical area
44 Outer edge

### 45 Annular web

46 Wider area

1. Container with lid, particularly a paint pot, where the container displays a container wall, a container bottom and a container opening and, in the edge area of the container opening, a continuous frame, projecting radially inwards relative to the container wall, into which the lid can be snapped or clamped, characterized in that the frame can be snapped onto the edge area of the container opening.

2. Container according to claim 1, characterized in that the frame extends beyond the opening-side face end of the container and its outer edge has an axial projection that engages a corresponding axial groove in the edge area of the container opening.

3. Container according to claim 2, characterized in that the projection and the groove extend over the circumference of the container.

4. Container according to claim 1, characterized in that snap-in means are provided on the inner side of the edge area of the container opening, which interact with snap-in means that extend radially outwards from a flange part.

5. Container according to claim 1, characterized in that the inner side of the edge area of the container opening displays a groove that is engaged in snap-fitting fashion by a corresponding projection that extends outwards from an essentially axially oriented flange part of the frame, or in that, instead of the groove, a projection is integrally molded on the inner side of the container wall, which snaps into a corresponding groove on the outer side of the essentially axially oriented flange part of the frame.

6. Container according to claim 5, characterized in that the flange part with the projection, and the groove on the inner side of the edge area of the container opening extend over the circumference of the container.

7. Container according to claim 2, characterized in that the axial projection of the frame and the axial groove of the edge area of the container opening, as well as the groove on the inner side of the edge area of the container wall and the projection on the flange part of the frame, are arranged and designed in such a way that the frame snapped onto the container sits on the container in fluid-tight fashion.

8. Container according to claim 1, characterized in that the container wall displays a greater thickness in the edge area of the container opening than in the remaining areas.

9. Container according to claim 8, characterized in that the outer side of the edge area of the container opening expands conically in relation to the inner side towards its opening-side face end.

10. Container according to claim 9, characterized in that the container displays two diametrically opposite pegs in the edge area of the container opening for fastening a strap, and the outer side of the edge area is of essentially cylindrical design in the area of the pegs.

11. Container according to claim 10, characterized in that each of the two ends of the strap displays an eye that is in each case radially opposite a peg and connected to the peg by ties, where the strap with the eyes in integrally molded on the container.

12. Container according to claim 1, characterized in that, in the radially outer area of the outer side of the container bottom, the container displays an axially projecting foot that, when stacking multiple containers with attached frames on each other, can engage a corresponding axial depression on the edge of the frame, as a result of which a further container stacked on top of the container can be radially fixed in place.

13. Container according to claim 1, characterized in that the container wall is of essentially conical design and the lower area of the inner side of the container displays multiple, essentially axially oriented stacking ribs distributed over the circumference, and the outer side of the container bottom is provided, at points correspondingly distributed over the circumference, with recesses that, when stacking multiple containers in each other, can be engaged by the stacking ribs of a container located beneath.

14. Container according to claim 12, characterized in that the foot is of essentially annular design and, at correspondingly distributed points, displays interruptions forming the recesses on the container bottom.

15. Container according to claim 1, characterized in that the container, the frame and the lid consist of different materials.

16. Method for manufacturing a container according to claim 1 and filling the container with material, characterized in that the container, the frame and the lid are each manufactured separately, the lid is fastened to the frame to form a unit, and the unit comprising lid and frame is fastened on the container after filling.
